(19) United States
(12) Patent Application Publication
(10) Pub. No.: US 2021/0281823 A1
(43) Pub. Date: Sep. 9, 2021

(54) DISPLAY SYSTEM, DISPLAY CONTROL DEVICE, AND NON-TRANSITORY COMPUTER READABLE MEDIUM

(71) Applicant: FUJIFILM BUSINESS INNOVATION CORP., Tokyo (JP)

(72) Inventor: Kazutoshi IKEDA, Kanagawa (JP)

(73) Assignee: FUJIFILM BUSINESS INNOVATION CORP., Tokyo (JP)

(21) Appl. No.: 16/922,668

(22) Filed: Jul. 7, 2020

(30) Foreign Application Priority Data
Mar. 4, 2020 (JP) 2020-037188

(51) Int. Cl. H04N 13/368; G06F 3/16; H04N 13/305; H04N 13/398

(52) U.S. Cl. CPC H04N 13/368; H04N 13/398; H04N 13/305; G06F 3/16

(57) ABSTRACT

A display system includes plural pixel sets, and a processor. The pixel sets are capable of displaying different images in plural directions. The processor is configured to determine a direction of a person, the person being a person able to view each of the pixel sets, the direction being a direction in which the person is located. The processor is also configured to, if the determined direction includes two or more determined directions, cause each of the pixel sets corresponding to the two or more directions to display a different image in each of the two or more directions.

### CROSS-REFERENCE TO RELATED APPLICATIONS

This application is based on and claims priority under 35 USC 119 from Japanese Patent Application No. 2020-037188 filed Mar. 4, 2020.

### BACKGROUND

### (i) Technical Field

The present disclosure relates to a display system, a display control device, and a non-transitory computer readable medium.

### (ii) Related Art

Japanese Unexamined Patent Application Publication No. 2019-160313 describes a technique related to digital signage. With the technique, content data distributed from a mobile terminal is displayed on a display by a playback terminal in accordance with schedule data distributed together with the content data.

For example, so-called digital signage refers to using, for advertising purposes, an information presentation apparatus that presents information by displaying an image or a video, emitting sound, or other methods. Digital signage is often viewed by a large number of people. If digital signage presents information in one fixed manner in such cases, situations occur in which some people are not interested in the information being presented, or some people start viewing sequentially-changing information midstream.

### SUMMARY

Aspects of non-limiting embodiments of the present disclosure relate to varying information to be received, depending on to whom the information is presented.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a display system includes plural pixel sets, and a processor. The pixel sets are capable of displaying different images in plural directions. The processor is configured to determine a direction of a person, the person being a person able to view each of the pixel sets, the direction being a direction in which the person is located. The processor is also configured to, if the determined direction includes two or more determined directions, cause each of the pixel sets corresponding to the two or more directions to display a different image in each of the two or more directions.

### BRIEF DESCRIPTION OF THE DRAWINGS

Exemplary embodiment of the present disclosure will be described in detail based on the following figures, wherein:

FIG. 1 illustrates the general arrangement of a multi-directional display system according to an exemplary embodiment;

FIG. 2 illustrates a lenticular sheet in enlarged view;

FIG. 3 illustrates an example of directions in which images are displayed;

FIG. 4 illustrates the hardware components of an image processing device;

FIG. 5 illustrates functional components implemented by an image processing device;

FIGS. 6A and 6B each illustrate an exemplary angle representing a person's direction;

FIG. 7 illustrates an exemplary operation procedure for a display process;

FIG. 8 illustrates the general arrangement of a multi-directional display system according to a modification;

FIG. 9 illustrates functional components implemented by an image processing device according to a modification; and

FIG. 10 illustrates functional components implemented by a multi-directional display system according to a modification.

### DETAILED DESCRIPTION

### 1. Exemplary Embodiment

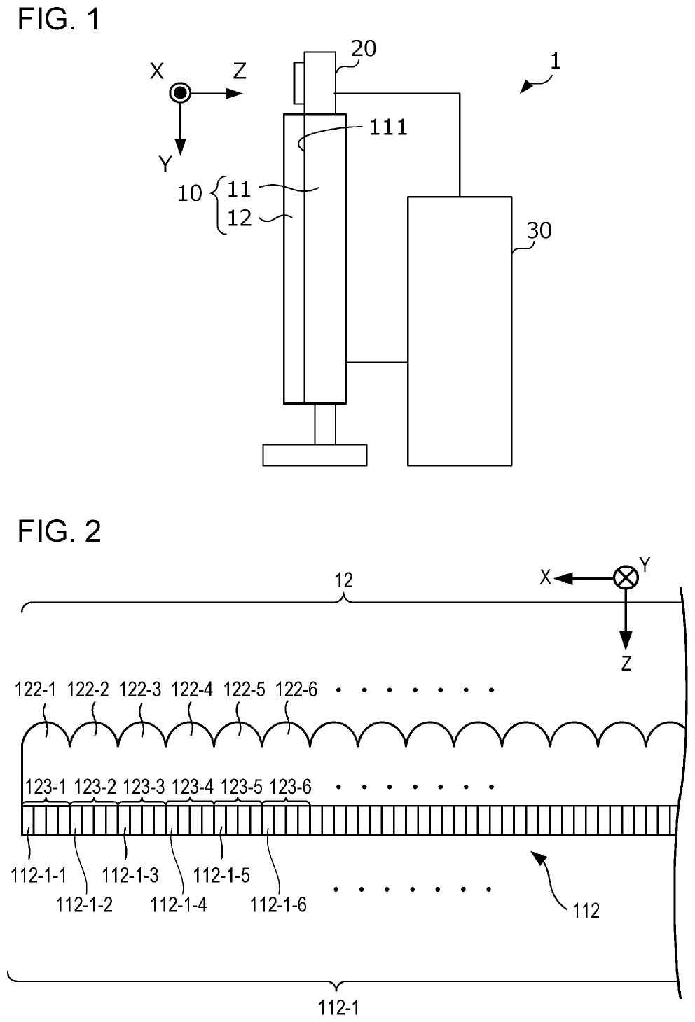

FIG. 1 illustrates the general arrangement of a multi-directional display system 1 according to an exemplary embodiment. The multi-directional display system 1 displays different images in plural directions. The multi-directional display system 1 is an example of a “display system” according to the exemplary embodiment of the present disclosure. The multi-directional display system 1 includes a display device 10, an imaging device 20, and an image processing device 30.

The display device 10 displays an image. The display device 10 has the function of displaying different images in plural directions. The display device 10 includes a display body 11, and a lenticular sheet 12. The display body 11 displays an image by use of light emitted from plural pixels arranged in a planar fashion. Although the display body 11 is, for example, a liquid crystal display, the display body 11 may be an organic electro-luminescence (EL) display, a plasma display, or other suitable displays.

The lenticular sheet 12 is attached on a display surface 111 of the display body 11. FIG. 1 depicts three-dimensional coordinate axes represented by an X-axis (axis in the horizontal direction) and a Y-axis (axis in the vertical direction), which are defined as the coordinate axes on a plane along the display surface 111, and a Z-axis whose positive direction is taken to be the direction opposite to the normal to the display surface 111. In the following description, a direction indicated by an arrow representing each axis will be referred to as positive direction, and the direction opposite to the positive direction will be referred to as negative direction. Further, the directions along the X-axis, the Y-axis, and the Z-axis will be respectively referred to as “X-axis direction”, “Y-axis direction”, and “Z-axis direction”.

The lenticular sheet 12 is formed by an arrangement of elongate convex lenses each having a part-cylindrical shape. The lenticular sheet 12 is attached on a side of the display surface 111 located in the negative Z-axis direction. The relationship between the lenticular sheet 12, and the pixels of the display body 11 will be described below with reference to FIG. 2.

FIG. 2 illustrates the lenticular sheet 12 in enlarged view. FIG. 2 is a schematic illustration, as viewed in the positive Y-axis direction, of the lenticular sheet 12, and a pixel part 112 of the display body 11.

The lenticular sheet 12 includes plural lens parts 122-1, 122-2, 122-3, 122-4, 122-5, 122-6, and so on (to be referred to as “lens part 122” or “lens parts 122” hereinafter when no distinction is made between individual lens parts). The pixel part 112 includes a pixel set 112-1. The pixel set 112-1 includes a pixel 112-1-1, a pixel 112-1-2, a pixel 112-1-3, a pixel 112-1-4, a pixel 112-1-5, a pixel 112-1-6, and so on.

As described above, each of the lens parts 122 is an elongate convex lens with a part-cylindrical shape. The lens parts 122 are arranged side by side in the X-axis direction. In other words, the lens parts 122 are arranged with their longitudinal direction extending along the Y-axis. In the case of FIG. 2, for example, opposed regions 123-1, 123-2, 123-3, 123-4, 123-5, 123-6, and so on (to be referred to as “opposed region 123” or “opposed regions 123” hereinafter when no distinction is made between individual opposed regions), which are regions opposed to the lens parts 122, each include four pixels arranged side by side in the X-axis direction.

For ease of illustration, each opposed region 123 is depicted in FIG. 2 to include four pixels arranged side by side in the X-axis direction. In practice, each opposed region 123 of the display body 11 includes a set of N pixels (N is a natural number). The number N in the exemplary embodiment is greater than four. Details in this regard will be given later.

Each pixel of the pixel set 112-1 is positioned at the end in the positive X-axis direction of the corresponding opposed region 123. A light ray emitted by each pixel of the pixel set 112-1 travels in the negative Z-axis direction, and is refracted in the same direction (to be referred to as “common direction” hereinafter) at the end in the positive X-axis direction of the corresponding lens part 122. Consequently, the light ray emitted by each pixel of the pixel set 112-1 reaches an eye of a person located in the common direction in which the light ray is refracted, thus displaying an image.

The same as mentioned above applies to pixel sets other than the pixel set 112-1, each of which is a set of pixels located at the same position in each corresponding opposed region 123. Light rays from the pixels of each pixel set are refracted in the same direction in the corresponding lens parts 122, and thus reach an eye of a person located in the common direction corresponding to the pixel set to thereby display an image. As described above, the display device 10 includes plural (N in the exemplary embodiment) sets of pixels, the pixel sets being capable of displaying different images in plural (N in the exemplary embodiment) different directions. The N pixels sets are arranged side by side in the X-axis direction.

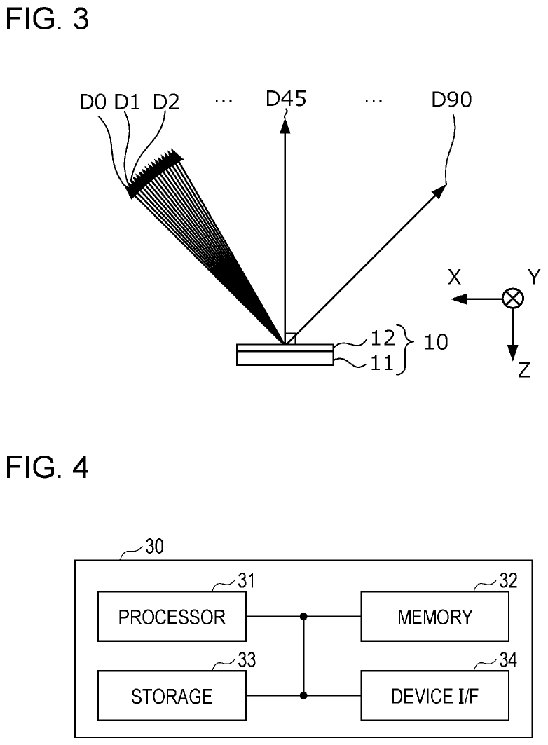

FIG. 3 illustrates an example of directions in which images are displayed. FIG. 3 illustrates the display device 10 (the display body 11 and the lenticular sheet 12) as viewed in the positive Y-axis direction. The display device 10 displays a different image in each of 91 different display directions such as display directions D0, D1, D2, D45, and D90. In other words, in the exemplary embodiment, the display device 10 includes 91 pixel sets.

The display direction D45 coincides with the direction of the normal to the display surface 111. The angle of each display direction differs by one degree. In other words, the display directions D0 and D90 each make an angle of 45 degrees with the display direction D45. In the following description, angles corresponding to directions located on the same side as the display directionD0 will be represented by negative values, and angles corresponding to directions located on the same side as the display direction D90 will be represented by positive values (which means that the display direction D0 corresponds to −45 degrees, and the display direction D90 corresponds to 45 degrees).

The imaging device 20 is, for example, a digital camera. The imaging device 20 is mounted vertically above the display device 10. The imaging device 20 has a lens directed in a direction (imaging direction) in which the display surface 111 is directed. The imaging device 20 captures, within its angle of view, images corresponding to all of the display directions depicted in FIG. 3. The display device 10 and the imaging device 20 are electrically connected with the image processing device 30 by a cable or other suitable connection. Alternatively, this connection may be made through wireless communication.

The image processing device 30 performs processing related to an image displayed by the display device 10 and an image captured by the imaging device 20.

FIG. 4 illustrates the hardware components of the image processing device 30. The image processing device 30 is a computer including a processor 31, a memory 32, a storage 33, and a device I/F 34. The processor 31 includes, for example, a processing unit such as a central processing unit (CPU), a register, and a peripheral circuit. The processor 31 is an example of a “processor” according to the exemplary embodiment of the present disclosure.

The memory 32 is a recording medium that is readable by the processor 31. The memory 32 includes, for example, a random access memory (RAM), and a read-only memory (ROM). The storage 33 is a recording medium that is readable by the processor 31. The storage 33 includes, for example, a hard disk drive, or a flash memory. By using the RAM as a work area, the processor 31 executes a program stored in the ROM or the storage 33 to thereby control operation of each hardware component.

The device I/F 34 serves as an interface (I/F) with two devices including the display device 10 and the imaging device 20. With the multi-directional display system 1, the processor 31 controls various components by executing a program, thus implementing various functions described later. An operation performed by each function is also represented as an operation performed by the processor 31 of a device that implements the function.

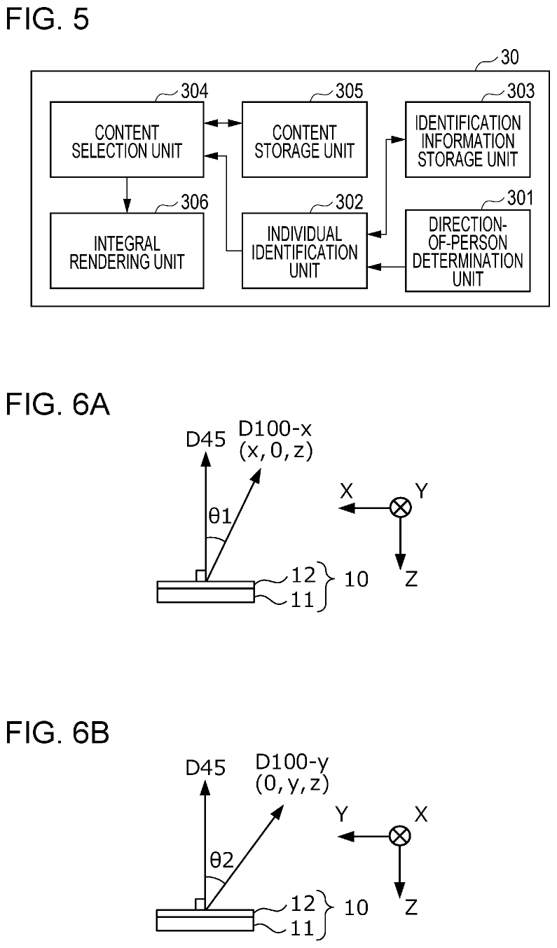

FIG. 5 illustrates functional components implemented by the image processing device 30. The image processing device 30 includes a direction-of-person determination unit 301, an individual identification unit 302, an identification information storage unit 303, a content selection unit 304, a content storage unit 305, and an integral rendering unit 306. The direction-of-person determination unit 301 determines the direction in which a person able to view each pixel set of the display device 10 described above is located with respect to the display device 10 (to be sometimes referred to as “person's direction” or “direction of a person” hereinafter).

For example, the direction-of-person determination unit 301 acquires an image captured by the imaging device 20, and recognizes, from the captured image, a person's face appearing in the image by use of a known face recognition technique. The direction-of-person determination unit 301 determines that a person whose face has been recognized is able to recognize the display surface 111 (i.e., pixel sets). The direction-of-person determination unit 301 then determines, based on where the recognized face is located within the image, the direction in which the person corresponding to the face is located. For example, the direction-of-person determination unit 301 determines a person's direction by using a direction table that associates the coordinates of each pixel with the direction in real space.

For example, the direction table is prepared in advance by the provider of the multi-directional display system 1 by placing an object in a specific direction in real space, and finding where the object appears within an image. In the exemplary embodiment, a person's direction is represented by, for example, an angle that the person's direction makes with the direction of the normal to the display surface 111 (the same direction as the display direction D45 depicted in FIG. 3). Specifically, a person's direction is represented by an angle that the person's direction makes in the X-axis direction with the direction of the normal, and an angle that the person's direction makes in the Y-axis direction with the direction of the normal.

In this regard, the angle that a person's direction makes in the X-axis direction with the direction of the normal refers to, with a vector representing the person's direction being projected on a plane including the X-axis and the Z-axis, an angle made by the projected vector with the direction of the normal. Likewise, the angle that a person's direction makes in the Y-axis direction with the direction of the normal refers to, with a vector representing the person's direction being projected on a plane including the Y-axis and the Z-axis, an angle made by the projected vector with the direction of the normal. These angles will be described below with reference to FIGS. 6A and 6B.

FIGS. 6A and 6B each illustrate an exemplary angle representing a person's direction. In FIGS. 6A and 6B, a person's direction D100 is represented by the coordinates (x, y, z) of a vector in a three-dimensional coordinate system with the center of the display surface 111 as its origin. FIG. 6A depicts a direction of projection D100-x (coordinates (x, 0, z)) in which the person's direction D100 is projected onto a plane including the X-axis and the Z-axis. An angle θ1 made by the direction of projection D100-x and the display direction D45 (the direction of the normal) is the angle that the person's direction D100 makes in the X-axis direction with the direction of the normal.

FIG. 6B depicts a direction of projection D100-y (coordinates (0, y, z)) in which the person's direction D100 is projected onto a plane including the Y-axis and the Z-axis. An angle θ2 made by the direction of projection D100-y and the display direction D45 (the direction of the normal) is the angle that the person's direction D100 makes in the Y-axis direction with the direction of the normal. In this way, the direction-of-person determination unit 301 determines the direction of a person who is able to view each set of pixels, based on the angle θ1 of the person's direction in the X-axis direction and the angle θ2 of the person's direction in the Y-axis direction.

In response to determining a person's direction, the direction-of-person determination unit 301 supplies directional information to the individual identification unit 302. The directional information represents the determined direction, and an image of a recognized face used in determining the direction. The individual identification unit 302 identifies the person whose direction has been determined by the direction-of-person determination unit 301. For example, the individual identification unit 302 identifies an individual based on features of a facial image represented by supplied directional information. Identification in this context means not to identify the personal name, address, and other such information of a person whose direction has been determined, but to make it possible to, if the person's face appears in another image, determine that the person appearing in the other image is the same person.

If a new person is identified, the individual identification unit 302 registers, into the identification information storage unit 303, information (e.g., a facial image) used in identifying the person as an individual. The identification information storage unit 303 stores person's identification information registered by the individual identification unit 302. In response to receiving supply of directional information from the direction-of-person determination unit 301, the individual identification unit 302 looks up the identification information storage unit 303 to check whether person's identification information represented by the supplied directional information has been registered in the identification information storage unit 303.

If no such identification information has been registered, the individual identification unit 302 supplies the person's identification information represented by the supplied directional information to the content selection unit 304, as information representing a newly identified individual. If such identification information has been registered, the individual identification unit 302 reads the registered person's identification information from the identification information storage unit 303, and supplies the read identification information to the content selection unit 304 as information representing an already-identified individual.

The content selection unit 304 selects, from among content items stored in the content storage unit 305, a content item to be presented to a person identified by identification information supplied from the individual identification unit 302. The content storage unit 305 stores a large number of pieces of content data each representing a content item for presentation to a person passing by in front of the multi-directional display system 1. A content item refers to representation, by an image (still or moving) and sound, of information desired for presentation to a person.

In response to receiving supply of identification information representing a newly identified individual, for example, the content selection unit 304 newly selects, as a content item to be presented, a content item that varies according to the current date and time. The content selection unit 304 may select a content item randomly, or may select plural previously prepared content items in sequential order. In either case, if two or more person's directions are determined, the content selection unit 304 may select a different content item for each direction in some cases (or may, alternatively, select the same content item for each direction in some cases).

If the content selection unit 304 receives supply of identification information representing an already identified individual, the content selection unit 304 again selects a content item previously selected for the identification information. The content selection unit 304 reads content data representing the selected content item from the content storage unit 305, and supplies the content data to the integral rendering unit 306. The integral rendering unit 306 renders, by use of a lenticular method, an image of the content item represented by the supplied content data.

Rendering refers to generating image data for display. Rendering using a lenticular method refers to generating image data for causing a pixel set to display an image, the pixel set being a set of pixels corresponding to a direction in which to display the image, the image data being representative of the values of all pixels. For example, if five directions are determined as directions of persons, the integral rendering unit 306 generates image data for causing each of pixel sets to display an image, the pixel sets corresponding to the five directions, the image being an image of a content item to be presented in each direction. In the exemplary embodiment, the integral rendering unit 306 assigns one pixel set to each one person.

As described above, the display device 10 includes N (91 in the exemplary embodiment) pixel sets. These pixel sets include a pixel set corresponding to a display direction not determined to be a direction in which a person is present. For such a pixel set corresponding to a display direction in which no person is present, the integral rendering unit 306 generates, for example, image data with all pixels set to the minimum value without performing any image rendering.

Each pixel is set to the minimum value in the above-mentioned case for the reason described below. When a pixel is emitting light, this exerts influence, in a greater or lesser degree, on light emitted by an adjacent pixel. For this reason, each pixel is set to the minimum value to minimize such influence. As described above, for a pixel set corresponding to a direction not determined by the direction-of-person determination unit 301 to be a direction in which a person is present, the integral rendering unit 306 generates, for example, image data with each pixel set to the minimum value so that no image is displayed.

The integral rendering unit 306 generates image data as described above. Consequently, if two or more directions of persons are determined, the integral rendering unit 306 causes a different image to be displayed for each of the determined directions by a pixel set corresponding to the direction. As a result, although presenting information from the same single display surface, the multi-directional display system 1 allows different pieces of information to be received by different persons, depending on to whom each piece of information is presented.

When the direction-of-person determination unit 301 determines a new person's direction, the content selection unit 304 selects a new content item. If a person's direction is determined for the first time, and a content item selected as a result is a video, the integral rendering unit 306 performs rendering so as to display, in the determined direction, an image of the video played from the beginning. This helps prevent, for example, a person passing by in front of the display device 10 from having to start viewing the video midstream.

If a person is identified once, the content selection unit 304 selects the same content item for that person. This means that if the direction of the person changes as the person moves, the integral rendering unit 306 continues to display an image of the same content item for that direction. Consequently, for example, if any person passes by in front of the display device 10, the person continues to view an image of the same content item.

Cases may occur in which, as a person who has been identified once moves, the person becomes hidden behind another person and no longer appears in an image captured by the imaging device 20. In that case, when the person appears in the captured image again, the direction of the person is determined by the direction-of-person determination unit 301. If the direction of an already identified person ceases to be determined and is then determined again as described above, the content selection unit 304 selects the same content item for the already identified person.

As a result, the integral rendering unit 306 causes an image to be displayed in the direction that is determined again, the image being a continuation of an image displayed at the time when the direction ceases to be determined. This means that, for example, if there is a person passing by in front of the display device 10, and if the person becomes temporarily unable to view the display device 10 when, for example, passing behind another person, the person continues to view an image of the same content item.

As a result of the above-mentioned configuration, each device included in the multi-directional display system 1 performs a display process that displays different images for different persons present in plural directions.

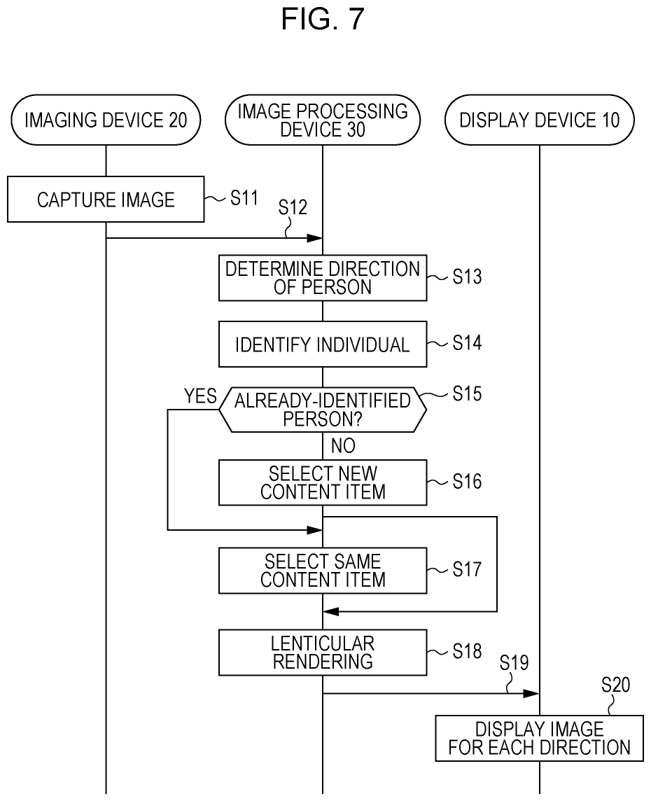

FIG. 7 illustrates an exemplary operation procedure for the display process. First, the imaging device 20 captures an image (step S11), and transmits the captured image to the image processing device 30 (step S12). The image processing device 30 (direction-of-person determination unit 301) determines the direction of a person appearing in the transmitted image (step S13).

Subsequently, the image processing device 30 (individual identification unit 302) identifies the person whose direction has been determined (step S14). The image processing device 30 (content selection unit 304) then determines whether the person identified this time is an already identified person (step S15). In response to determining that the person identified this time is a new, not-yet-identified person (NO), the image processing device 30 (content selection unit 304) selects a new content item (step S16).

In response to determining that the person identified this time is an already identified person (YES), the image processing device 30 (content selection unit 304) selects the same content item as that already selected for that person (step S17). After step S16 or S17, the image processing device 30 (integral rendering unit 306) renders an image of the selected content item by a lenticular method (step S18).

Then, the image processing device 30 (integral rendering unit 306) transmits, to the display device 10, display image data generated by the rendering (step S19). By using the transmitted image data, the display device 10 displays an image for each determined direction (step S20). The operations from step S11 to S20 are repeated while the display device 10 displays an image for each direction in which a person is present.

### 2. Modifications

The exemplary embodiment mentioned above is only illustrative of one exemplary embodiment of the present disclosure, and may be modified as described below. The exemplary embodiment and its various modifications may be implemented in combination as necessary.

### 2-1. Method for Determining Person's Direction

In the foregoing description of the exemplary embodiment, the direction-of-person determination unit 301 determines the direction of a person by recognizing the person's face. However, the direction-of-person determination unit 301 may not necessarily determine a person's direction by this method. Alternatively, for example, the direction-of-person determination unit 301 may determine the direction of a person by detecting an eye of the person from an image, or may determine the direction of a person by detecting the whole body of the person.

If a person is carrying a communication terminal including a positioning unit (a unit that measures the position of the communication terminal), such as a smartphone, the direction-of-person determination unit 301 may acquire positional information representing a position measured by the communication terminal, and determine a person's direction from the relationship between the acquired positional information, and previously stored positional information of the display device 10. In that case, the person's direction is determined even without the imaging device 20.

### 2-2. Groups

In some cases, an image of a content item displayed by the display device 10 is viewed by a group of several persons. A group in this case is, for example, a family, friends, or a boyfriend and a girlfriend. The multi-directional display system 1 may present an image of the same content item to persons belonging to such a group. In this modification, for example, the content selection unit 304 infers, for plural persons whose directions have been determined, the inter-personal relationship between these persons from the relationship between their respective directions.

The content selection unit 304 calculates, for example, a mean value θ11, and a mean value θ12. The mean value θ11 is the mean value of angles that two directions determined for two persons make with respect to the horizontal direction during a predetermined period of time, and the mean value θ12 is the mean value of angles that the two directions make with respect to the vertical direction during the predetermined period of time. If the mean value θ11 is less than a threshold Th11, and the mean value θ12 is less than a threshold Th21, the content selection unit 304 infers the two persons to be a husband and a wife, or a boyfriend and a girlfriend. If the mean value θ11 is less than a threshold Th12, and the mean value θ12 is less than the threshold Th21, the content selection unit 304 infers the two persons to be friends. In this regard, the threshold Th12 is greater than the threshold Th11.

The thresholds are set as above for the reason described below. Although a husband and a wife, a boyfriend and a girlfriend, and friends move while keeping a certain distance from each other, the degree of intimacy is higher for a husband and a wife and for a boyfriend and a girlfriend than for friends. The content selection unit 304 infers the two persons to be a parent and a child if the mean value θ11 is less than the threshold Th11, and if the mean value θ12 is greater than or equal to a threshold Th22 and less than a threshold Th23. The thresholds are set as mentioned above because in the case of a parent and a child, their degree of intimacy is high but their faces are vertically spaced apart from each other due to their relative heights.

If one of two persons previously inferred to be friends is inferred to be a friend of another person, these three persons are collectively inferred to be friends by the content selection unit 304. In the same manner, the content selection unit 304 infers a large number of persons to be a group of friends. If the number of persons in a group is greater than or equal to a predetermined number (e.g., about 10), the content selection unit 304 infers the group to be not a group of friends but a group of classmates or teammates.

Once the inter-personal relationship between plural persons is inferred as described above, the content selection unit 304 selects the same content item for these persons inferred to have a specific inter-personal relationship. For example, for plural persons inferred to be a husband and a wife, a boyfriend and a girlfriend, or friends, the content selection unit 304 selects the same content item for each person. By contrast, for plural persons inferred to be a parent and a child, the content selection unit 304 selects a different content item for each person.

As a result of the above-mentioned content item selection, the integral rendering unit 306 causes an image of the same content item to be displayed toward each of plural persons inferred to have a specific inter-personal relationship. Thus, an image of the same content item is presented for a group of persons having a specific inter-personal relationship.

### 2-3. Assignment of Pixel Sets

In the foregoing description of the exemplary embodiment, the integral rendering unit 306 assigns one pixel set to each one person. Alternatively, the integral rendering unit 306 may assign two or more pixel sets to each one person. Assigning two or more pixel sets means that the integral rendering unit 306 generates, for two or more pixel sets, image data used for displaying the same image, and causes the two or more pixel sets to display the same image.

For example, if plural persons are inferred to have the specific inter-personal relationship mentioned with reference to the above modification, the integral rendering unit 306 causes a number of pixel sets to display the same image, the number varying according to the number of these persons. Examples of the specific inter-personal relationship include a husband and a wife, a boyfriend and a girlfriend, friends, a group of friends, and classmates. For example, the greater the number of persons, the greater the number of pixel sets assigned by the integral rendering unit 306.

Specifically, although the integral rendering unit 306 assigns one pixel set to each one person, if there are plural persons having a specific inter-personal relationship, the integral rendering unit 306 assigns, for example, twice as many pixel sets as the number of such persons (e.g., four pixel sets for two persons, or six pixel sets for three persons). In this regard, if only one set of pixels is assigned to each one person, when the person moves, a time lag (the time necessary for determining a direction, identifying an individual, and selecting a content item) occurs until the adjacent pixel set displays the same image. This results in an image flashing phenomenon in which the image momentarily disappears and then appears again.

The greater the number of pixel sets, the higher the probability of the adjacent pixel set displaying the same image at the time when the person moves, and hence the lower the probability of the image flashing phenomenon occurring. However, there is a limit to the number of pixel sets, and thus assigning an unlimited number of pixel sets to one person reduces the number of pixel sets assigned to other persons. In this regard, a case is now considered in which the same image is to be presented to two or more persons with a high degree of intimacy, such as a husband and a wife. In this case, even if another image is displayed in a direction between the directions of the two persons, it is unlikely for the image to be viewed by persons other than the two persons.

Accordingly, in this modification, an increased number of pixel sets are assigned as mentioned above. This allows for effective utilization of such pixel sets while reducing the image flashing phenomenon, in comparison to assigning a single fixed number of pixel sets. The term effective utilization in this context refers to reducing the image flashing phenomenon by not using those pixel sets likely to be used in the future to display images for other persons but having such pixel sets readily available for future use whenever the occasion arises, and instead using those pixel sets unlikely to be used to display images for other persons.

The integral rendering unit 306 may, in response to plural persons being inferred to have a specific inter-personal relationship, cause a number of pixel sets to display the same image, the number varying according to the degree of density of these persons. The integral rendering unit 306 determines the degree of density as follows: the smaller the mean value θ11 (the mean value of angles made by two directions with respect to the horizontal direction) and the mean value θ12 (the mean value of angles made by two directions with respect to the vertical direction), the higher the degree of density.

For example, the integral rendering unit 306 increases the number of assigned pixel sets as the degree of density of plural persons increases. The higher the degree of density of plural persons, the lower the probability of another image displayed in a direction between these persons being viewed by another person. Therefore, this configuration as well allows for effective utilization of pixel sets while reducing the image flashing phenomenon, in comparison to assigning a single fixed number of pixel sets.

### 2-4. Gestures

A gesture-based operation on an image may be accepted, the gesture being made by a person viewing the image. In this modification, for example, the direction-of-person determination unit 301 determines the direction of a person, and also determines a predetermined movement performed by a specific part of the person. An example of a predetermined movement performed by a person's specific part is the movement of raising a hand or the movement of lowering a hand.

For example, the direction-of-person determination unit 301 determines a predetermined movement of a hand by using a known technique that recognizes the skeleton of a person appearing in an image (e.g., the technique disclosed in Japanese Unexamined Patent Application Publication No. 2019-211850). In this regard, the imaging device 20 used in this modification is a camera capable of acquiring three-dimensional image data, such as a stereo camera. In response to determining that there has been a predetermined movement performed by a person's specific part, the direction-of-person determination unit 301 supplies movement information to the individual identification unit 302, the movement information representing a facial image of the person whose movement of the specific part has been determined.

The individual identification unit 302 reads identification information of the person whose movement of the specific part has been determined, and supplies the identification information to the content selection unit 304. The content selection unit 304 selects a new content item for presentation to the person identified by the supplied identification information. For example, if the content item being currently selected for the person is a part of a multi-part series, the content selection unit 304 selects the next content item in the same multi-part series.

The content selection unit 304 may select another language version of the same content item, or may randomly select a new content item. The content selection unit 304 may select the same content item again. In that case, if the reselected content item is, for example, a video, the video is played again from the beginning.

With a content item selected as described above, the integral rendering unit 306 displays an image toward a person whose direction has been determined, the image varying in content according to a movement performed by a specific part of the person. This means that a person (viewer) to whom to present a content image changes the content image on the person's own will by making the person's specific part perform a predetermined movement.

### 2-5. Directional Sound

The multi-directional display system may not only display an image but also emit sound.

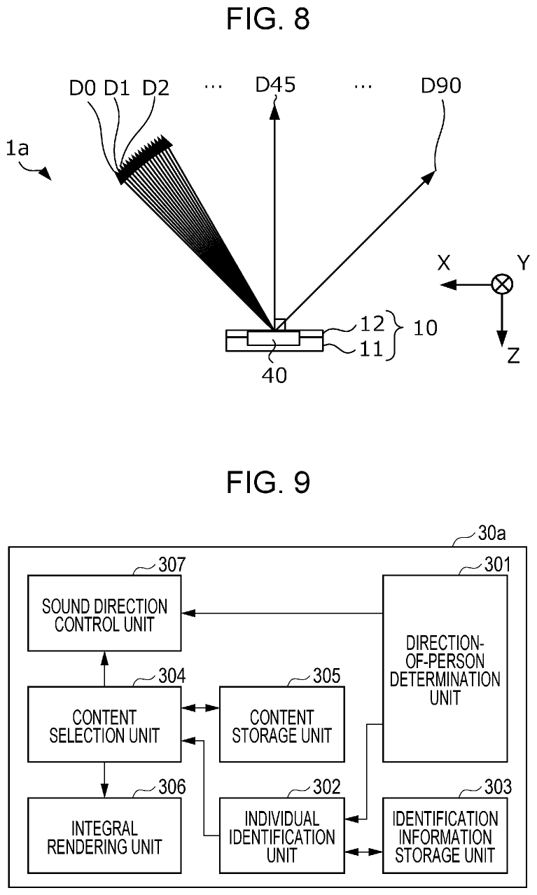

FIG. 8 illustrates the general arrangement of a multi-directional display system 1a according to a modification. The multi-directional display system 1a includes the display device 10, and a directional speaker 40 (an imaging device and an image processing device are not illustrated).

The directional speaker 40 emits sound in a direction selected from among plural directions. The directional speaker 40 emits sound in 91 directions including display directions such as D0, D1, D2, D45, and D90 illustrated in FIG. 3.

FIG. 9 illustrates functional components implemented by an image processing device 30a according to this modification. The image processing device 30a includes a sound direction control unit 307 in addition to the units depicted in FIG. 5.

The content selection unit 304 supplies content data representing a selected content item also to the sound direction control unit 307. The sound direction control unit 307 also receives supply of information from the direction-of-person determination unit 301, the information representing a determined direction of a person. The sound direction control unit 307 causes the directional speaker 40 to emit audio in a direction represented by supplied directional information, that is, in the direction of a person determined by the direction-of-person determination unit 301, the audio being the audio of a video to be displayed in the direction. As a result, each person whose direction has been determined hears a different piece of audio.

### 2-6. Communication Terminal

The multi-directional display system may, when a person is carrying around a communication terminal, determine the person's direction or select a content item based on information obtained from the communication terminal.

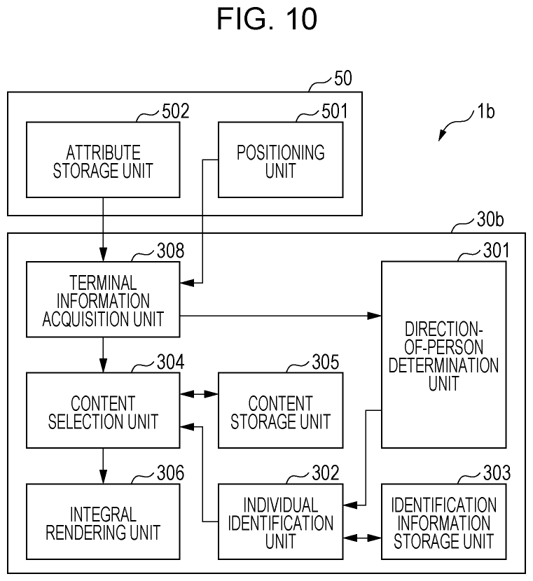

FIG. 10 illustrates functional components implemented by a multi-directional display system 1b according to this modification. The multi-directional display system 1b includes an image processing device 30b, and a communication terminal 50 (an imaging device and an image processing device are not illustrated).

The image processing device 30b includes a terminal information acquisition unit 308 in addition to the units depicted in FIG. 5. The communication terminal 50 includes a positioning unit 501, and an attribute storage unit 502. The positioning unit 501 measures the position of the communication terminal 50. For example, the positioning unit 501 measures the position of the communication terminal 50 within an error of several centimeters by use of the real-time kinematic (RTK) technique. The positioning unit 501 transmits positional information to the image processing device 30b, the positional information representing the measured position and a terminal ID for identifying the communication terminal 50.

The terminal information acquisition unit 308 of the image processing device 30b acquires the transmitted positional information as terminal information related to the communication terminal 50 carried around by a person. The terminal information acquisition unit 308 supplies the acquired positional information to the direction-of-person determination unit 301. The direction-of-person determination unit 301 determines the direction of the person based on the position represented by the supplied positional information. Specifically, the direction-of-person determination unit 301 stores the position of the display device 10 in advance, and determines the direction of the person based on the stored position and the position represented by the supplied positional information.

The attribute storage unit 502 of the communication terminal 50 stores an attribute of a person who is carrying the communication terminal 50. Examples of an attribute include a person's age, sex, hobbies, shopping history, or other such information, which can be used in determining what the person's hobbies or tastes are. The attribute storage unit 502 transmits attribute information to the image processing device 30b, the attribute information representing a stored attribute and a terminal ID. The terminal information acquisition unit 308 acquires the transmitted attribute information as terminal information related to the communication terminal 50 carried around by the person.

As described above, the terminal information acquisition unit 308 acquires terminal information through radio communication with the communication terminal of a person whose direction has been determined, and supplies the acquired terminal information to the content selection unit 304. The content selection unit 304 selects a content item that varies according to an attribute represented by the supplied attribute information. The content selection unit 304 selects the content item by use of a content table, which associates each attribute with a type of content item.

The content table associates each attribute with a type of content item such that, for example, the age attribute “10s” is associated with cartoons or variety shows, the age attribute “20s and 30s” is associated with variety shows or dramas, and the age attribute “40s and 50s” is associated with dramas or news shows. The content selection unit 304 selects a content item of a type associated in the content table with an attribute represented by attribute information.

With a content item selected as described above, the integral rendering unit 306 causes an image to be displayed in the direction of the person carrying the communication terminal 50, the image varying according to the terminal information acquired from the communication terminal 50. This ensures that, for example, even if a person is in a crowd and it is not possible to recognize the person's face from an image captured by the imaging device 20, a content image is presented to that person.

### 2-7. Route to Destination

When a person carrying around the communication terminal 50 is walking toward a given destination, the multi-directional display system may present a route to the destination. In that case, the terminal information acquisition unit 308 acquires, as terminal information, destination information representing the destination of the person carrying around the communication terminal 50. An example of information used as such destination information is, if a schedule is managed by the communication terminal 50, information representing a place where the latest planned activity described in the schedule is to take place.

Alternatively, for example, if a search for a store has been performed with the communication terminal 50, information representing the store may be used as destination information. If plural stores have been searched for, information representing the last searched-for store, a store to which a call has been made, or the longest-viewed store may be used as destination information. In response to acquiring destination information, the terminal information acquisition unit 308 supplies the acquired destination information to the content selection unit 304.

The content selection unit 304 selects, as a content item, an image representing a route to a destination represented by the supplied destination information. Specifically, the content selection unit 304 stores, in advance, information representing the location where the display device 10 is installed, generates, by using the function of a map app, an image representing a route from the installation location to a destination, selects the generated image as a content item, and supplies the selected content item to the integral rendering unit 306.

With a content item selected as described above, the integral rendering unit 306 causes an image to be displayed as an image that varies according to terminal information acquired from the communication terminal 50, the image representing a route from the location of the display device 10 to a destination represented by the terminal information. This ensures that a route to a destination is presented to a person carrying around the communication terminal 50 even without the person specifying the destination.

### 2-8. Lenticular Sheet

In the foregoing description of the exemplary embodiment, the lenticular sheet is formed by plural lens parts 122 arranged side by side in the X-axis direction, each lens part 122 being an elongate convex lens having a part-cylindrical shape. However, this is not intended to be limiting. The lenticular sheet may be formed by, for example, plural lens parts arranged side by side in a planar fashion and in a lattice-like form in the X- and Y-axis directions, the lens parts each being a convex lens.

The display body according to this modification includes, in each opposed region opposed to the corresponding lens part, a set of N (N is a natural number) pixels arranged in the X-axis direction, and a set of M (M is a natural number) pixels arranged in the Y-axis direction. This means that the display body includes, in addition to each set of pixels arranged in the X-axis direction, each set of pixels arranged in the Y-axis direction. By using a lenticular method, the integral rendering unit 306 performs rendering for each such set of pixels arranged in the Y-axis direction. The display device according to this modification thus displays an image for each direction determined with respect to the X-axis direction and for each direction determined with respect to the Y-axis direction. As a result, for example, different images are displayed for an adult, who generally has a high eye level, and a child, who generally has a low eye level.

### 2-9. Functional Components

With the multi-directional display system 1, a method for implementing the functions illustrated in FIG. 5 or other figures is not limited to the method described above with reference to the exemplary embodiment. For example, if the display device 10 includes hardware components corresponding to those illustrated in FIG. 4, then the display device 10 may implement all the functions depicted in FIG. 5 or other figures. The display device 10 may have the imaging device 20 incorporated therein, or may further have the directional speaker 40 incorporated therein.

In such cases, the display device 10 alone constitutes an example of the “display system” according to the exemplary embodiment of the present disclosure. As described above, the “display system” according to the exemplary embodiment of the present disclosure may include all of its components within a single enclosure, or may include its components located separately in two or more enclosures. The imaging device 20 may constitute a part of the display system, or may be a component external to the display system.

For example, in the modification mentioned above, the content selection unit 304 infers the inter-personal relationship between plural persons. Alternatively, a function for performing this inference may be provided separately. Further, for example, the operations performed by the content selection unit 304 and the integral rendering unit 306 may be performed by a single function. In short, as long as the functions illustrated in FIG. 5 or other figures are implemented by the multi-directional display system 1 as a whole, the specific configuration of devices that implement each function, and the range of operations performed by each function may be freely determined.

### 2-10. Processor

In the embodiment above, the term “processor” refers to hardware in a broad sense. Examples of the processor includes general processors (e.g., CPU: Central Processing Unit), and dedicated processors (e.g., GPU: Graphics Processing Unit, ASIC: Application-Specific Integrated Circuit, FPGA: Field Programmable Gate Array, and programmable logic device).

In the embodiment above, the term “processor” is broad enough to encompass one processor or plural processors in collaboration which are located physically apart from each other but may work cooperatively. The order of operations of the processor is not limited to one described in the embodiment above, and may be changed.

### 2-11. Category of Present Disclosure

The exemplary embodiment of the present disclosure may be understood as, in addition to a display device, an imaging device, and an image processing apparatus, a display system including these devices. The exemplary embodiment of the present disclosure may be also understood as an information processing method for implementing a process performed by each device, or as a program for causing a computer to function, the computer controlling each device. This program may be provided by means of a storage medium in which the program is stored, such as an optical disc. Alternatively, the program may be provided in such a manner that the program is downloaded to a computer via communications lines such as the Internet, and installed onto the computer to make the program available for use.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A display system comprising:
a plurality of pixel sets capable of displaying different images in a plurality of directions; and
a processor configured to
determine a direction of a person, the person being a person able to view each of the plurality of pixel sets, the direction being a direction in which the person is located, and
if the determined direction comprises two or more determined directions, cause each of the plurality of pixel sets corresponding to the two or more directions to display a different image in each of the two or more directions.

2. The display system according to claim 1,
wherein the processor is configured to
identify the person whose direction has been determined, and
in response to the direction of the identified person changing as the identified person moves, cause the same image to be continued to be displayed in the direction.

3. The display system according to claim 2,
wherein the processor is configured to, in response to the direction of the identified person being determined again after ceasing to be determined, cause an image to be displayed in the direction determined again, the image being a continuation of an image displayed at a time when the direction ceases to be determined.

4. The display system according to claim 1,
wherein the processor is configured to,
if the person whose direction has been determined comprises a plurality of persons, infer, from a relationship between respective directions of the plurality of persons, an inter-personal relationship between the plurality of persons, and
if the plurality of persons include a plurality of persons inferred to have a specific inter-personal relationship, cause the same image to be displayed toward each of the plurality of persons inferred to have the specific inter-personal relationship.

5. The display system according to claim 4,
wherein the processor is configured to cause a number of the plurality of pixel sets to display the same image, the number varying according to a number of the plurality of persons inferred to have the specific inter-personal relationship.

6. The display system according to claim 4,
wherein the processor is configured to cause a number of the plurality of pixel sets to display the same image, the number varying according to a degree of density of the plurality of persons inferred to have the specific inter-personal relationship.

7. The display system according to claim 5,
wherein the processor is configured to cause a number of the plurality of pixel sets to display the same image, the number varying according to a degree of density of the plurality of persons inferred to have the specific inter-personal relationship.

8. The display system according to claim 1,
wherein the processor is configured to cause an image to be displayed toward the person whose direction has been determined, the image varying in content according to a movement performed by a specific part of the person.

9. The display system according to claim 2,
wherein the processor is configured to cause an image to be displayed toward the person whose direction has been determined, the image varying in content according to a movement performed by a specific part of the person.

10. The display system according to claim 3,
wherein the processor is configured to cause an image to be displayed toward the person whose direction has been determined, the image varying in content according to a movement performed by a specific part of the person.

11. The display system according to claim 4,
wherein the processor is configured to cause an image to be displayed toward the person whose direction has been determined, the image varying in content according to a movement performed by a specific part of the person.

12. The display system according to claim 5,
wherein the processor is configured to cause an image to be displayed toward the person whose direction has been determined, the image varying in content according to a movement performed by a specific part of the person.

13. The display system according to claim 6,
wherein the processor is configured to cause an image to be displayed toward the person whose direction has been determined, the image varying in content according to a movement performed by a specific part of the person.

14. The display system according to claim 7,
wherein the processor is configured to cause an image to be displayed toward the person whose direction has been determined, the image varying in content according to a movement performed by a specific part of the person.

15. The display system according to claim 1,
wherein the processor is configured to, if the direction of the person is determined for a first time, cause an image to be displayed in the direction, the image being an image of a video played from a beginning.

16. The display system according to claim 1, further comprising
a speaker having directivity, the speaker being configured to emit sound in a direction selected from among the plurality of directions,
wherein the processor is configured to cause the speaker to emit audio in the determined direction of the person, the audio being audio of a video displayed in the direction.

17. The display system according to claim 1,
wherein the processor is configured to
perform radio communication with a communication terminal, the communication terminal being carried around by the person whose direction has been determined, and
cause an image to be displayed in the direction of the person, the image varying according to information acquired from the communication terminal.

18. The display system according to claim 17,
wherein the processor is configured to cause an image to be displayed as the image varying according to the information acquired from the communication terminal, the image to be displayed representing a route from a location of a display device to a destination represented by the information, the display device including the plurality of pixel sets.

19. A display control device comprising:
a plurality of pixel sets capable of displaying different images in a plurality of directions; and
a processor configured to
determine a direction of a person, the person being a person able to view each of the plurality of pixel sets, the direction being a direction in which the person is located, and
if the determined direction comprises two or more directions, cause each of the plurality of pixel sets corresponding to the two or more directions to display a different image in each of the two or more directions.

20. A non-transitory computer readable medium storing a program causing a computer to execute a process, the computer including a plurality of pixel sets and a processor, the plurality of pixel sets being capable of displaying different images in a plurality of directions, the process comprising:
determining a direction of a person, the person being a person able to view each of the plurality of pixel sets, the direction being a direction in which the person is located; and
if the determined direction comprises two or more directions, causing each of the plurality of pixel sets corresponding to the two or more directions to display a different image in each of the two or more directions.
